(19) United States
(12) Patent Application Publication
(10) Pub. No.: US 2005/0111151 A1
(43) Pub. Date: May 26, 2005

(54) Isolation circuit for a communication system

(76) Inventor: Don T. Lam, Fountain Valley, CA (US)

Correspondence Address: Blakely, Sokoloff, Taylor & Zafman LLP, Suite 101, 5285 S.W. Meadows Road, Lake Oswego, OR, 97035, US

(21) Appl. No.: 10/722,853

(22) Filed: Nov. 25, 2003

(51) Int. Cl. H02H 3/18

(52) U.S. Cl. 361/86; 713/300; 714/100

(57) ABSTRACT

A method and apparatus to isolate signals are described.

### BACKGROUND

Some communication systems implement critical functions that require uninterrupted service, such as emergency “911” services, for example. These systems are sometimes referred to as “high-availability” systems. A high-availability system is typically comprised of a number of components. If one of the components fails or becomes corrupted, it may impact the operation of the entire system. Techniques to isolate the point of failure from the rest of the system may reduce potential interruptions to the entire system. Consequently, there may be need for improvements in such techniques in a device or network.

### BRIEF DESCRIPTION OF THE DRAWINGS

The subject matter regarded as the embodiments is particularly pointed out and distinctly claimed in the concluding portion of the specification. The embodiments, however, both as to organization and method of operation, together with objects, features, and advantages thereof, may best be understood by reference to the following detailed description when read with the accompanying drawings in which:

FIG. 1 illustrates a system suitable for practicing one embodiment;

FIG. 2 illustrates a block diagram for a management module in accordance with one embodiment;

FIG. 3 illustrates a block diagram of an isolation circuit in accordance with one embodiment; and

FIG. 4 is a circuit diagram of an isolation circuit in accordance with one embodiment.

### DETAILED DESCRIPTION

Numerous specific details may be set forth herein to provide a thorough understanding of the embodiments of the invention. It will be understood by those skilled in the art, however, that the embodiments of the invention may be practiced without these specific details. In other instances, well-known methods, procedures, components and circuits have not been described in detail so as not to obscure the embodiments of the invention. It can be appreciated that the specific structural and functional details disclosed herein may be representative and do not necessarily limit the scope of the invention.

It is worthy to note that any reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

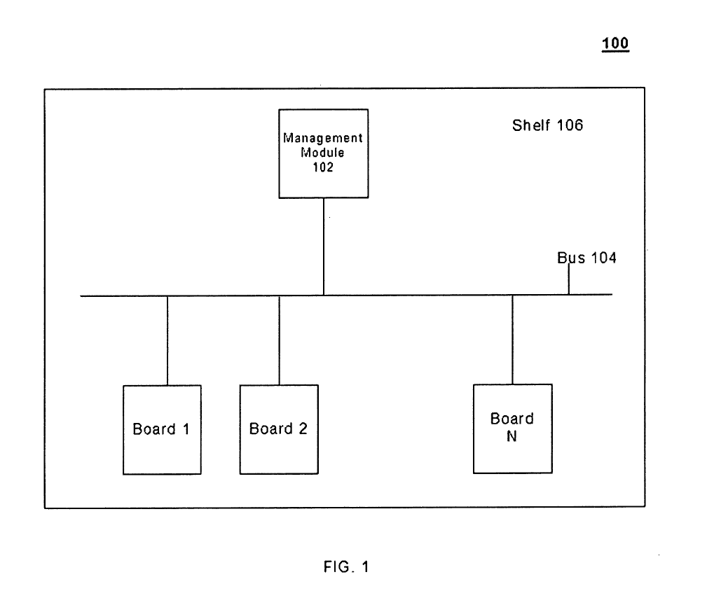

Referring now in detail to the drawings wherein like parts are designated by like reference numerals throughout, there is illustrated in FIG. 1 a system suitable for practicing one embodiment. FIG. 1 is a block diagram of a system 100. System 100 may comprise a high-availability system implemented as a modular platform. A modular platform may be designed using modular building blocks, such as shelves, compute boards, management modules, Field Replaceable Units (FRU), and other components. In one embodiment, for example, system 100 may comprise an Advanced Telecommunications Computing Architecture (ATCA) system as defined by the PCI Industrial Computer Manufacturers Group (PICMG) 3.x family of specifications, such as the ATCA specification PICMG 3.0, dated Dec. 30, 2002.

System 100 may be implemented as one or more network nodes in any number of wired or wireless communication systems. The term “network node” as used herein may refer to any node capable of communicating information in accordance with one or more protocols. The term 'protocol” as used herein may refer to a set of instructions to control how the information is communicated over the communications medium, such as control and data fields, length of the fields, content of the fields, message sequencing, and so forth. For example, system 100 may comprise communication infrastructure equipment such as a Radio Network Controller (RNC), Serving GPRS Support Node (SGSN), Media Gateway (MG), a carrier grade telecom server, and so forth. The embodiments are not limited in this context.

In one embodiment, system 100 may use one or more communications mediums. The term “communications medium” as used herein may refer to any medium capable of carrying information signals. Examples of communications mediums may include metal leads, semiconductor material, twisted-pair wire, co-axial cable, fiber optic, radio frequencies (RF) and so forth. The terms “connection” or “interconnection,” and variations thereof, in this context may refer to physical connections and/or logical connections.

In one embodiment, for example, system 100 may comprise a RNC connected by one or more communications mediums comprising RF spectrum for a wireless network, such as a cellular or mobile system. In this case, the network nodes and/or networks shown in system 100 may further comprise the devices and interfaces to convert the packet signals carried from a wired communications medium to RF signals. Examples of such devices and interfaces may include omni-directional antennas and wireless RF transceivers. The embodiments are not limited in this context.

Referring again to FIG. 1, system 100 may comprise, among other things, a management module 102, a bus 104, boards 1-N, and a shelf 106. Although FIG. 1 shows a limited number of components, it can be appreciated that system 100 may comprise any number of additional components desired for a given implementation.

In one embodiment, system 100 may comprise a plurality of boards 1-N. Boards 1-N may comprise a single or dual-processor single board computer (SBC). In one embodiment, for example, boards 1-N may comprise one or more ATCA compliant boards, such as the Intel® NetStructure™ MPCBL0001 SBC made by Intel Corporation (“SBC 0001 Board”). The SBC 0001 Board may support a single or dual low-voltage Intel Xeon™ processors at 1.6 Gigahertz (GHz) or 2.0 GHz with a 400 Megahertz (MHz) system bus and an integrated 512 kilobyte L2 cache. The SBC 0001 Board may include the Intel E7501 chipset and supports a 4 Gigabyte (GB) of DDR266 ECC registered SDRAM in four DIMM sockets. The SBC 0001 Board may include backplane connections for dual Gigabit Ethernet and optional dual Fibre Channel interconnects. Compliant with IPMI 1.5, the SBC 0001 Board includes an Intelligent Platform Management Controller (IPMC) to monitor, control and perform diagnostic functions using dual Intelligent Platform Management Bus (IPMB) connections. Although the SBC 0001 Board is described by way of example, it can be appreciated that boards 1-N are not limited in this context.

In one embodiment, system 100 may comprise a bus 104. Bus 104 may communicate information signals between boards 1-N and other components of system 100, such as management module 102. In one embodiment, for example, bus 104 may comprise an ATCA compliant bus, such as a two-way redundant implementation of the IPMB, which is based on the inter-integrated circuit (I²C) bus and is part of the IMPI architecture. When implemented as part of an ATCA shelf, the main IPMB is typically referred to as IPMB-0, and is implemented on either a bused or radial basis. Each entity attached to IPMB-0 does so via an IPMC, the distributed management controller of the IPMI architecture. Shelf managers, such as management module 102, attach to IPMB-0 via a variant IPMC referred to as a Shelf Management Controller (ShMC). Although the IPMB is described by way of example, it can be appreciated that bus 104 is not limited in this context.

In one embodiment, system 100 may comprise a shelf 106. Shelf 106 may comprise a chassis to house the other components of system 100. Shelf 106 may also comprise various components to provide functionality to management module 102 and boards 1-N (“shelf components”). For example, shelf 106 may comprise shelf components such as power supplies, cooling fans, sensors and other shared components. In one embodiment, for example, shelf 106 may comprise an ATCA compliant shelf, such as the Intel NetStructure MPCHC0001 14U shelf made by Intel Corporation (“14U Shelf”). The 14U Shelf may provide 14 board slots vertically mounted in a 14U enclosure. The 14U Shelf may provide high thermal capacity with a hot-swappable fan tray assembly designed to support the demands of telecommunications infrastructure equipment by providing efficient front-to-rear cooling up to 200 Watts (W) per slot. The 14U Shelf may be designed to reduce single points of failure with support for redundant—48 VDC power feeds and dual redundant chassis management modules (CMM), the latter of which are part of management module 102. The 14U Shelf is designed to Network Equipment Building System (NEBS) Level 3 and European Telecommunications Standards Institute (ETSI) standards. Although the 14U Shelf is described by way of example, it can be appreciated that shelf 106 is not limited in this context.

In one embodiment, system 100 may comprise a management module 102. Although one or more embodiment have been described in terms of “modules” to facilitate description, one or more circuits, components, registers, processors, software subroutines, or any combination thereof could be substituted for one, several, or all of the modules.

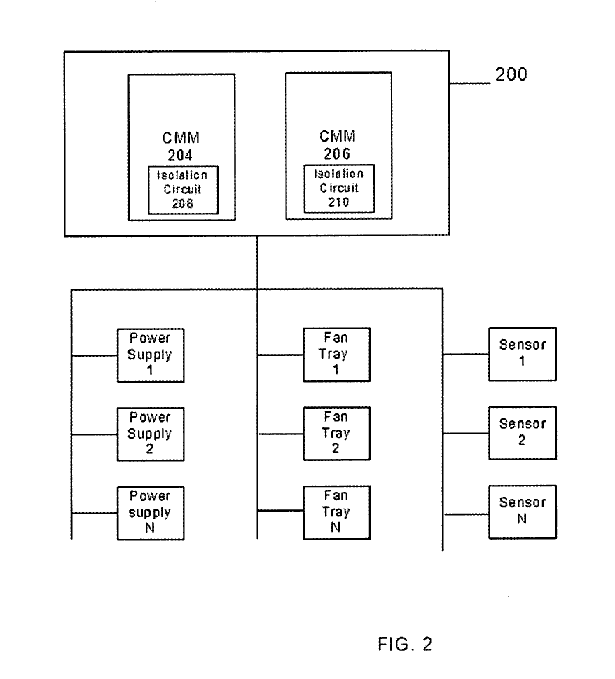

In one embodiment, management module 102 may perform centralized system management for system 100. In one embodiment, for example, management module 102 may comprise an ATCA compliant management module, such as the Intel NetStructure MPCMM0001 Chassis Management Module (CMM). The CMM may attempt to improve service availability in a modular platform compliant with ATCA specifications, by offloading management applications from the host processor. The CMM provides centralized shelf management by managing up to 16 board slots, multiple shelf sensors, and a redundant CMM. The CMM may query information from one or more FRU, detects presence, performs thermal management for shelf 106, and performs health monitoring for each component. It also provides power management and controls the power-up sequencing of each component and the power-on/off to each board slot. The CMM may identify the shelf components to be monitored and implements the IPMI 1.5 standard through a hybrid dual-star management topology to gather and report metrics for specific modules and boards. The CMM may support multiple management interfaces, including the Remote Management Control Protocol (RMCP), Remote Procedure Calls (RPC), Simple Network Management Protocol (SNMP) v1 and v3, IPMI 1.5 over IPMB, Command Line Interface (CLI) over serial port, Telnet, and SSH Secure Shell, for example. Although the CMM is described by way of example, it can be appreciated that management module 102 is not limited in this context. Management module 102 may be discussed in more detail with reference to FIG. 2.

In addition to the above, system 100 may comprise other components typically found in a modular platform. For example, boards 1-N may each be connected by a packet-based backplane designed to communicate packets between boards 1-N in accordance with one or more communication protocols. A packet in this context may refer to a set of information of a limited length, with the length typically represented in terms of bits or bytes. An example of a packet length might be 1000 bytes. The backplane may operate in accordance with any number of layered fabric backplane specifications, such as PCI Express, Ethernet, Fast Ethernet, Gigabit Ethernet, StarFabric, Fibre Channel, and other architectures.

FIG. 2 illustrates a block diagram for a management module in accordance with one embodiment. FIG. 2 illustrates a management module 200. Management module 200 may be representative of, for example, management module 106. Although FIG. 2 shows a limited number of components, it can be appreciated that management module 200 may comprise any number of additional components desired for a given implementation.

In one embodiment, management module 200 may comprise a CMM 204 and CMM 206. CMM 204 may be a primary CMM, while CMM 206 may be a secondary CMM that takes over system management functions in case of failure or maintenance of CMM 204.

One of the design constraints for high-availability systems is to avoid a single point of failure that might affect operations of the entire system. If a component or module fails for any reason it should not cause the whole system to cease operations. Since management module 200 electrically connects to other modules in shelf 106, it can potentially become a single point of failure for system 100. Failure of management module 200 may occur for any number of reasons, such as a failing power supply or some of its signals become shorted or stuck. To reduce this scenario, CMM 204 and CMM 206 each have isolation circuits 208 and 210, respectively.

In one embodiment, the isolation circuits may isolate some or all of the interconnectivity among the primary CMM, the secondary CMM, and other modules in shelf 106 communicating via the CMMs. There may be a substantial number of connections among CMM 204 and 206, such as the IPMB buses, status control signals, temperature monitoring signals, FRU memory devices, and so forth (referred to herein as “shared signals”). For example, management module 200 may monitor or communicate signals between power supplies 1-N, fan trays 1-N, and sensor 1-N. These may represent only a few of the connections among CMM 204 and 206, and the embodiments are not limited in this context. In one embodiment, for example, each CMM may share an average of 85 signals. Thus the number of shared signals to be isolated for a CMM 204 and CMM 206 may be approximately 170. A cost-effective isolation circuit having a small footprint may be desired since the isolation circuit, or portions thereof, may need to be replicated for each shared signal. It may be appreciated that the number of shared signals handled by an isolation circuit is not limited in this context.

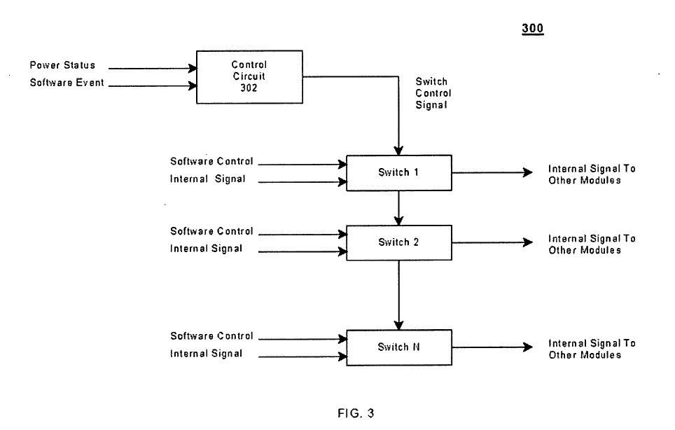

FIG. 3 illustrates a block diagram of an isolation circuit in accordance with one embodiment. FIG. 3 illustrates an isolation circuit 300. Isolation circuit 300 may be representative of, for example, isolation circuits 208 and 210. Although FIG. 3 shows a limited number of components, it can be appreciated that isolation circuit 300 may comprise any number of additional components desired for a given implementation.

In one embodiment, isolation circuit 300 may comprise a control circuit 302. Control circuit 302 may be connected a plurality of switches 1-N. In one embodiment, isolation circuit 300 may be implemented as part of the CMM. It may be appreciated, however, that isolation circuit 300 may be implemented anywhere in system 100 where there are shared signals.

In one embodiment, isolation circuit 300 may comprise a control circuit 302. Control circuit 302 may be implemented using an N-channel Metal Oxide Semi-conductor Field Effect Transistor (MOSFET), for example. In operation, control circuit 302 may receive as input a power status signal and a software event signal. The power status signal may originate from a circuit monitoring the power supply for shelf 106, such as power supplies 1-N. The software event signal may originate from an application program executing on a host processor for shelf 106 or a processor on one of boards 1-N. The application program may generate the software event signal automatically on detection of a power interruption to shelf 106 or a CMM. The application program may also generate the software event signal in response to instructions from a user via, for example, a management user interface.

Control circuit 302 may receive as input the power status signal and the software event signal. Control circuit 302 may output a switch control signal based on one or both input signals. For example, the switch control signal may comprise a switch close signal if the power status is valid. The term “valid” as used herein may refer to an operational state of the power supply. The switch control signal may comprise a switch open signal if the power status is invalid. The term “invalid” as used herein may refer to a non-operational state or failure condition of the power supply.

In one embodiment, isolation circuit 300 may comprise a plurality of switches 1-N. Switches 1-N may comprise any switching element that operates in open and closed states, such as a relay, a bi-polar transistor, a MOSFET, and so forth. In one embodiment, each shared signal considered a part of the interconnection to external modules may have a corresponding switch. Switches 1-N may be turned on or off collectively by control circuit 302 or individually by an application program. Further, a single control circuit may control all the switches 1-N, with the switch element being replicated in accordance with the number of shared signals to be isolated.

In one embodiment, each switch may receive as input the switch control signal, a component signal (e.g., internal signal), and a software control signal. Each switch may be used to isolate the component signal from the rest of system 100 in accordance with the switch control signal. For example, when the switch is in a closed state, the component signal may be communicated to other modules of system 100. When the switch is in an open state, however, the opened switch may prevent communication of the component signal to the other modules of system 100, thereby effectively isolating the shared signal and reducing the potential that it may disrupt other portions of system 100.

In one embodiment, control circuit 300 may receive power from one or more power supplies of shelf 106. If power to control circuit 300 is disrupted for any reason, control circuit may be configured to drive the switches to an open state. This may isolate the component signals from the external boards in case of failure of portions of isolation circuit 300 itself.

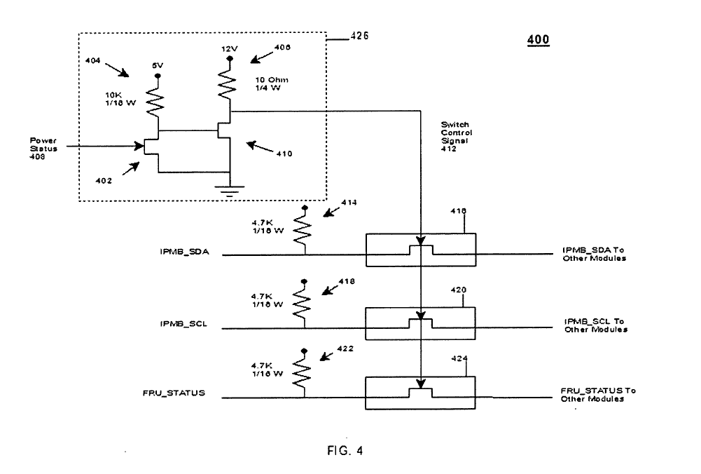

FIG. 4 is a circuit diagram of an isolation circuit in accordance with one embodiment. FIG. 4 illustrates an isolation circuit 400. Isolation circuit 400 may represent an implementation of an isolation circuit, such as isolation circuit 300, for example. As shown in FIG. 4, isolation circuit 400 may comprise a control circuit 426 and switches 416, 420 and 424. Switches 416, 420 and 424 may be connected to resistors 414, 418 and 422, respectively, each of which operating as a pull up resistor. Control circuit may comprise resistors 404 and 406, and transistors 402 and 410. Although FIG. 4 shows a limited number of components, it can be appreciated that isolation circuit 400 may comprise any number of additional components desired for a given implementation.

In one embodiment, for example, switches 416, 420 and 424 of isolation circuit 400 maybe implemented using a LittleFoot® MOSFET SI1024 because of its relatively low cost and small package size. The SI1024 has dual N-channel FETs in an SC-89 package. In one embodiment, control circuit 426 may be implemented using a single SI1024.

In operation, a power status signal 408 may be driven to a TTL logic high when the system power is within normal operating parameters. A first MOSFET 402 is turned ON and a second MOSFET 410 is turned OFF. 12 Volts (V) will source current through a 10 Ohm resistor 406, which acts as a current limiting resistor. This will cause a switch control signal 412 to keep switches 416, 420 and 424 in an ON (i.e., closed) state. This may connect the component signals IPMB_SDA, IPMB_SCL and FRU_STATUS to the external modules. When the system power is out of regulation or completely lost, power status signal 408 may be driven to TTL logic low. This may cause first MOSFET 402 to be turned OFF, which in turn causes second MOSFET 410 to be turned ON. Switch control signal 412 will drive switches 416, 420 and 424 to an OFF (i.e., open) state, which will isolate both sides of the signals.

The embodiments may be implemented using an architecture that may vary in accordance with any number of factors, such as desired computational rate, power levels, heat tolerances, processing cycle budget, input data rates, output data rates, memory resources, data bus speeds and other performance constraints. For example, one embodiment may be implemented using software executed by a processor. The processor may be a general-purpose or dedicated processor, such as a processor made by Intel® Corporation, for example. The software may comprise computer program code segments, programming logic, instructions or data. The software may be stored on a medium accessible by a machine, computer or other processing system. Examples of acceptable mediums may include computer-readable mediums such as read-only memory (ROM), random-access memory (RAM), Programmable ROM (-PROM), Erasable PROM (EPROM), magnetic disk, optical disk, and so forth. In one embodiment, the medium may store programming instructions in a compressed and/or encrypted format, as well as instructions that may have to be compiled or installed by an installer before being executed by the processor. In another example, one embodiment may be implemented as dedicated hardware, such as an Application Specific Integrated Circuit (ASIC), Programmable Logic Device (PLD) or Digital Signal Processor (DSP) and accompanying hardware structures. In yet another example, one embodiment may be implemented by any combination of programmed general-purpose computer components and custom hardware components. The embodiments are not limited in this context.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

1. An isolation circuit, comprising:
a control circuit to receive as input a power status signal, said control circuit to output a switch control signal, said switch control signal to comprise a switch close signal if said power status is valid, and a switch open signal if said power status is invalid; and
at least one switch to connect to said control circuit, said switch to receive said switch control signal and a component signal and operate in accordance with said switch control signal, with said switch to prevent communication of said component signal when said switch is in an open state.

2. The isolation circuit of claim 1, wherein said control circuit receives as input a software event signal, and said control circuit outputs said control signal in accordance with said software event signal.

3. The isolation circuit of claim 1, wherein said switch receives as input a software control signal, and said switch switches between said open state and a closed state in accordance with said software control signal.

4. The isolation circuit of claim 1, further comprising a plurality of switches, each switch to connect to said control circuit, said plurality of switches to each receive said switch control signal and a component signal and operate in accordance with said switch control signal, with said plurality of switches to prevent communication of said component signals when said switch is in an open state.

5. The isolation circuit of-claim 1, wherein said control circuit receives power from a power supply, and when said control circuit fails to receive said power said control circuit drives said switch to an open state.

6. The isolation circuit of claim 1, wherein said control circuit and said switch comprise at least one N-channel MOSFET.

7. A system, comprising:
a bus;
a shelf having a plurality of shelf components;
a management module to connect to said bus, said management module to manage a plurality of signals communicated between said shelf components; and
wherein said management module comprises an isolation circuit to isolate said signals if one of said shelf components becomes inoperative.

8. The system of claim 7, wherein said isolation circuit comprises:
a control circuit to receive as input a power status signal, said control circuit to output a control signal, said control signal to comprise a switch close signal if said power status is valid, and a switch open signal if said power status is invalid; and
at least one switch to connect to said control circuit, said switch to receive said control signal and at least one of said shelf component signals and operate in accordance with said control signal, with said switch to prevent communication of said shelf component signal when said switch is in an open state.

9. The system of claim 7, wherein said control circuit receives power from a power supply, and when said control circuit fails to receive said power said control circuit drives said switch to an open state.

10. The system of claim 7, wherein said control circuit receives as input a software event signal, and said control circuit outputs said control signal in accordance with said software event signal.

11. The system of claim 7, wherein said switch receives as input a software control signal, and said switch switches between said open state and a closed state in accordance with said software control signal.

12. A circuit comprising:
a plurality of switches, with each switch configured to receive a component signal;
a control circuit to electrically couple to said plurality of switches, said control circuit to comprise a dual N-channel MOSFET to receive a power status signal;
wherein a first MOSFET is turned on and a second MOSFET is turned off when said power status signal is a TTL logic high, and to source current to each switch to allow said component signal to be communicated to an external module; and
wherein said first MOSFET is turned off and said second MOSFET is turned on when said power status signal is a TTL logic low, and to remove said current from each switch to isolate said component signals from said external modules.

13. The circuit of claim 12, wherein each switch comprises a dual N-channel MOSFET configured to default to an off state when power is removed.

14. The circuit of claim 12, wherein each switch may be turned on or off by a software control signal.

15. A method to isolate a signal, comprising:
receiving a power status signal at a control circuit;
receiving a component signal at a switch; and
isolating said component signal at said switch in accordance with said power status signal.

16. The method of claim 15, wherein said isolating comprises:
closing said switch to allow said component signal to be communicated to an external module if said power status signal is valid; and
opening said switch to prevent said component signal from being communicated to said external module if said power status is invalid.

17. The method of claim 16, wherein said closing comprises:
receiving said power status signal indicating a TTL logic high at said control circuit; and
sending current to close said switch.

18. The method of claim 16, wherein said opening comprises:
receiving said power status signal indicating a TTL logic low at said control circuit; and
removing current to open said switch.

19. The method of claim 15, wherein said isolating comprises:
receiving a software event signal from an application program at said control circuit; and
opening said switch to prevent said component signal from being communicated to an external module in accordance with said software event signal.

20. The method of claim 15, wherein said isolating comprises:
receiving a software control signal from an application program at said switch; and
opening said switch to prevent said component signal from being communicated to an external module in accordance with said software control signal.
